(19) United States
(12) Patent Application Publication
(10) Pub. No.: US 2002/0057574 A1
(43) Pub. Date: May 16, 2002

(54) Wheel lighting device

(76) Inventors: David R. Dalton, Turramurra (AU); John R. Brown, Mosman (AU); Adam Shipway, Crows Nest (AU)

Correspondence Address: ROBERT W WELSH, EVEREADY BATTERY COMPANY INC, 25225 DETROIT ROAD, P O BOX 450777, WESTLAKE, OH, 44145

(21) Appl. No.: 10/010,284

(22) Filed: Nov. 1, 2001

(30) Foreign Application Priority Data
Nov. 13, 2000 (AU) PR1466

(51) Int. Cl. B62J 6/00

(52) U.S. Cl. 362/473; 362/500

(57) ABSTRACT

A lighting device for attaching to a spoked wheel emits light in the direction of the rim of the wheel, and in a direction parallel to the axis of rotation of the wheel; and which has a housing in an aerofoil shape.

### CROSS-REFERENCE TO RELATED APPLICATIONS

This application claims priority under 35 U.S.C. § 119(e) on Australian Provisional Patent Application No. PR1466, entitled “WHEEL LIGHTING DEVICE,” filed Nov. 13, 2000 by David R. Dalton, et al, the entire disclosures of which are incorporated herein by reference.

### FIELD OF THE INVENTION

The present invention relates to lighting devices of the kind useable with a spoked wheel of a vehicle, to enable light to be visible when the vehicle is in use. Such a spoked wheel may be a bicycle wheel.

### BACKGROUND OF THE INVENTION

The riding of bicycles can be particularly dangerous at night time when the rider is not visible to drivers of automobiles. This can be particularly problematic when the rider is approaching a T-intersection and an automobile is waiting to turn into or across the path of the bicycle rider. There has been a long felt need to make bicycle riders and/or their bicycles more visible to automobile drivers.

### SUMMARY OF THE INVENTION

The present invention provides a lighting device having a housing to house a voltage source, a lamp means and a switch means, so that when said switch means closes a circuit between said source and said lamp means light will be emitted from said device, said housing including attachment means to attach said housing to a spoked wheel, whereby said housing allows a substantial proportion of light generated to be emitted in the direction of a rim of said spoked wheel and in a direction parallel to the axis of rotation of said spoked wheel and directions therebetween, said housing being of an aerofoil shape.

The lens portion can be integrally formed with the housing or be separate thereto and attached to the housing.

The attachment means can be two engaging portions located on said housing at opposite ends thereof

A first engaging portion can be at one end of said device to engage a first spoke and a second engaging portion at an opposite end of said device to engage a second spoke to thereby retain said spokes in said to engaging portions. The first and second engaging portions can be stationary or one can be stationary while the other is moveable. The engaging portions can be pivoted about a securing screw, before said screw is secured.

The switch means can be manually operated or can be a switch which is activated by movement of the lighting device. Alternatively the lighting device can include a combination of a movement and manually operated switch in the mechanism.

The lamp means can be an LED, or an incandescent globe. The LED can be of a cone angle of approximately 30° to 50°.

During operation of said lamp said circuit can be opened and closed intermittently. Alternatively said circuit can be made to remain in a closed condition.

The engaging portions can be hooks. The device is preferably substantially symmetrical in the direction of motion around the axis of rotation of said spoked wheel.

Preferably the housing includes a bulbous centre portion. The housing can be bulbous in at least one direction which is orthogonal to a longitudinal axis of said housing. Alternatively the housing can be bulbous in at least two directions which are orthogonal to a longitudinal axis of said housing. A positive and negative direction along the same vector is to be considered one direction.

Preferably the housing is aerofoil shaped, and is preferably constructed from back to back aerofoil shaped halves.

When a lens is provided the housing can be made from a transparent or a non transparent material. When the light is emitted through the housing the housing will need to be of a transparent material.

The housing can include reflector formations on the outside thereof if the housing is manufactured from non transparent material, or reflector formations on the inside of the housing when the housing is manufactured from a transparent material. The reflector formations can serve the purpose of reflecting light from vehicles or other sources

Preferably when the engaging portion is moveable it is slidably mounted in a slot on said device. Said slot having a longitudinal axis which extends in the direction from said first to said second engaging portion.

The lighting device can include a battery holder which slides into and out of said lighting device. The battery holder preferably includes a generally planar holding portion into which a battery can be placed. The holding portion can have two cantilevered arms which hold said battery around a circumference thereof and which can apply a compressive force thereto. Preferably the battery holder will receive and hold a disc shaped cell, and to hold said cell in a plane generally parallel to a joining plane of halves of said lighting device. The battery holder can slide into and out of said lighting device through a port on the axle side of said lighting device when mounted on a spoked wheel.

The present invention provides a lighting device having a voltage source, a lamp means and lens, so that when a circuit is closed between said source and said lamp means light will be emitted from said device via said lens, said device being attachable to spokes of a spoked wheel by means of two engaging portions, a first engaging portion being stationary at one end of said device to engage a first spoke and a second moveable engaging portion at an opposite end of said device to engage a second spoke to there by retaining said spokes in said to engage in portions.

The device can include a housing to house said source, said lamp means and said lens whereby light is emitted from said lens in the direction of a rim of said spoked wheel and in a direction which is parallel to the axis of rotation of said spoked wheel.

The lighting device can include a manually operated switch to close the circuit between said source and said lamp. Alternatively, said device can include a movement switch means whereby rotation or movement of the wheel causes the circuit between said lamp and said source to close. Alternatively the lighting device can include a combination of a movement and manually operated switch in the mechanism.

During operation of said lamp preferably said circuit between said source and said lamp is opened and closed intermittently. Alternatively said circuit is made to remain either in the closed or open position.

The engaging portions can be hooks. The device is preferably substantially symmetrical in the direction of motion around the axis of rotation of said spoked wheel.

Preferably the housing includes a bulbous centre portion.

Preferably the housing is aerofoil shaped, and is preferably constructed from back to back aerofoil shaped halves.

Preferably the moveable engaging portion is slidably mounted in a slot on said device. Said slot having a longitudinal axis which extends in the direction from said first to said second engaging portion.

The present invention also provides a bicycle wheel and lighting device in combination wherein said bicycle wheel has a rim having its exposed surfaces being of a reflective material so that light emitted by said device when mounted on said spokes of said wheel will be reflected from said rim.

### BRIEF DESCRIPTION OF THE DRAWINGS

An embodiment of the present invention will now be described, by way of example only, with reference to the accompanying drawings in which:

FIG. 1 illustrates a top view of a lighting device;

FIG. 2 illustrates a front view of the lighting device of FIG. 1;

FIG. 3 illustrates an underside view of the lighting device of FIG. 1;

FIG. 4 illustrates an end view of the lighting device of FIG. 1; and

FIG. 5 illustrates a perspective view of the lighting device of FIG. 1.

FIG. 6 illustrates a right side view of another lighting device embodiment;

FIG. 7 illustrates a left side view of the apparatus of FIG. 6;

FIG. 8 illustrates a front elevation;

FIG. 9 illustrates a bottom view of the apparatus of FIG. 6;

FIG. 10 illustrates a rear elevation of the apparatus of FIG. 6;

FIG. 11 illustrates a top elevation of the apparatus of FIG. 6;

FIG. 12 illustrates a cross section through the line X1iii through FIG. 11; and

FIG. 13 illustrates the apparatus of FIGS. 6 to 12 in use on a spoked wheel.

### DETAILED DESCRIPTION OF THE EMBODIMENTS

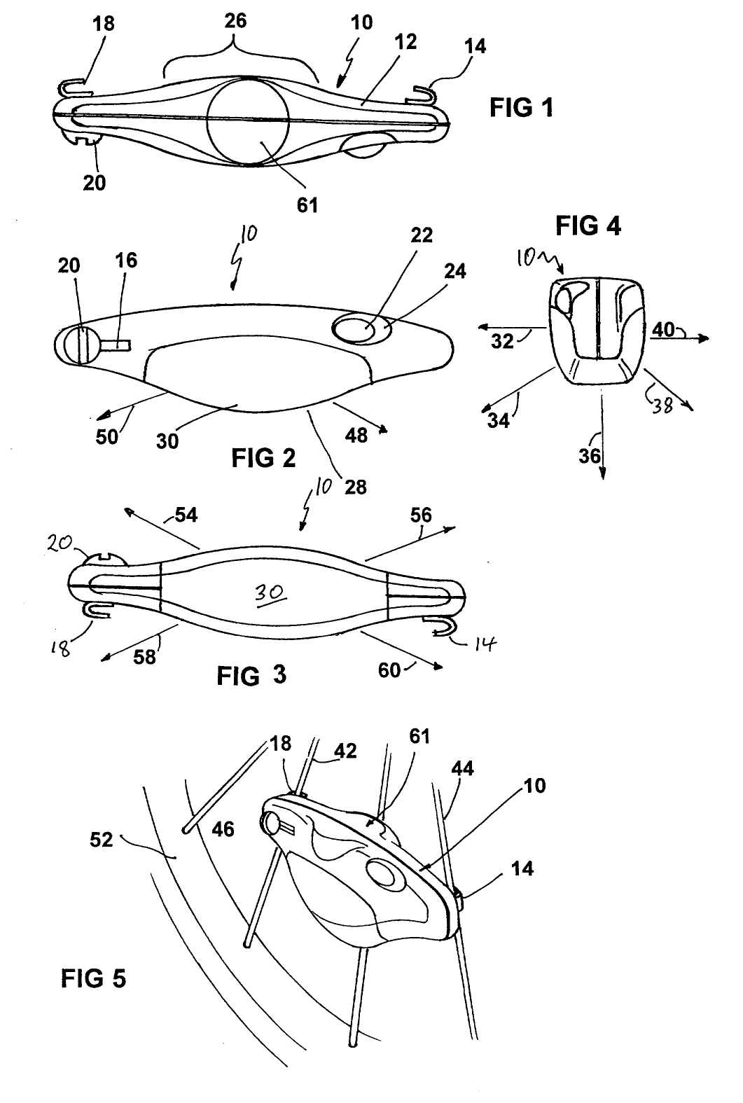

As illustrated in FIGS. 1 to 5 the lighting device 10 has in plan view a generally streamlined symmetrical body 12 which has as its rear a stationary hook 14 on its right side whilst at its left side the body includes a slot 16 in which is slidably mounted an adjustable hook 18 which can be releasably secured to the body 12 by means of screw 20.

On the front upper portion of the body 12 is an on/off switch 22 which is raised from the surface of the body 12 as is illustrated in FIG. 1 so that a user can identify the switch by feel in addition to or instead of by sight. The body 12 in the vicinity of switch 22 also includes a depression 24 to direct a user's finger onto the switch 22.

As can be seen from FIG. 1 the centre portion, generally marked by the numeral 26 has a bulbous shape or a shape made from back to back aerofoil shaped halves. The bulbous portion extends into the space between the hooks 14 and 18.

As can be seen from FIG. 2 the lower portion of the lighting device 10 has a lens 30, which is included in a downwardly projecting bulbous portion 28. Through the lens, 30 light will be emitted by a lamp means, such as an LED, contained inside the body 12. The rear view though not illustrated is substantially identical to the front view of FIG. 2 except that the switch 22 and the screw head 20 would not be visible with the hooks 14 and 18 being visible.

As can be seen from FIG. 4, the lens 30 is of a generally U-shaped cross and the lamp means is positioned so as to emit light: in the directions of arrows 32, 34, 36, 38 and 40 and directions in between as in FIG. 4; in the direction of arrows 48 and 50 and directions in between as in FIG. 2; and in the directions of arrows 54, 56, 58 and 60 and directions in between as in FIG. 3, when the lighting device 10 is mounted onto the spokes 42 and 44 of a spoked wheel 46 as illustrated in FIG. 5.

The light emitted from the lighting device 10, in addition to radiating laterally, when in use on a spoked wheel 46 will cause the illumination of the rim 52. With the rim 52 being reflective this will help to reflect light in directions other than those indicated by arrows in FIGS. 2 and 4, and in this way the greater proportion of the light is used to indicate to automobile drivers the presence of the moving bicycle.

As can be seen from FIGS. 1 and 5, the top portion of the lighting device 10 includes a generally cylindrical portion 60 in which is laterally housed a 3 volt lithium cell. If desired the voltage source being a lithium cell could be arranged so as to lie generally in a vertical plane and thus provide an even more streamlined upper portion of the lighting device 10.

To attach the lighting device 10 to a spoked wheel 46, the hook 14 is first placed onto a spoke such as spoke 44. The adjustable hook 18 is moved to a location so as to loop a second spoke. Then once the position of the lighting device 10 is decided upon, the hook 18 is moved towards the hook 14 thereby clamping the two spokes therebetween, so as to hold the lighting device 10 in position on the spokes 42 and 44. If desired additional securing mechanisms can be utilised in order to ensure that the lighting device 10 does not move from the position in which it is placed.

The body 12 includes a circuit board (not illustrated) for the mounting of the lamp means. The circuit can also include a switching circuit so that once the switch 22 is in the closed position, the lamp means will flash or turn on and off intermittently. If desired, in the circuit between the switch 22 and lamp means there can be provided a motion operated switch whereby movement of the wheel will cause the switch to close and thus cause the lamp means to emit light either intermittently or continuously. Such motion switches can be a reed switch or possibly a mercury switch if desired.

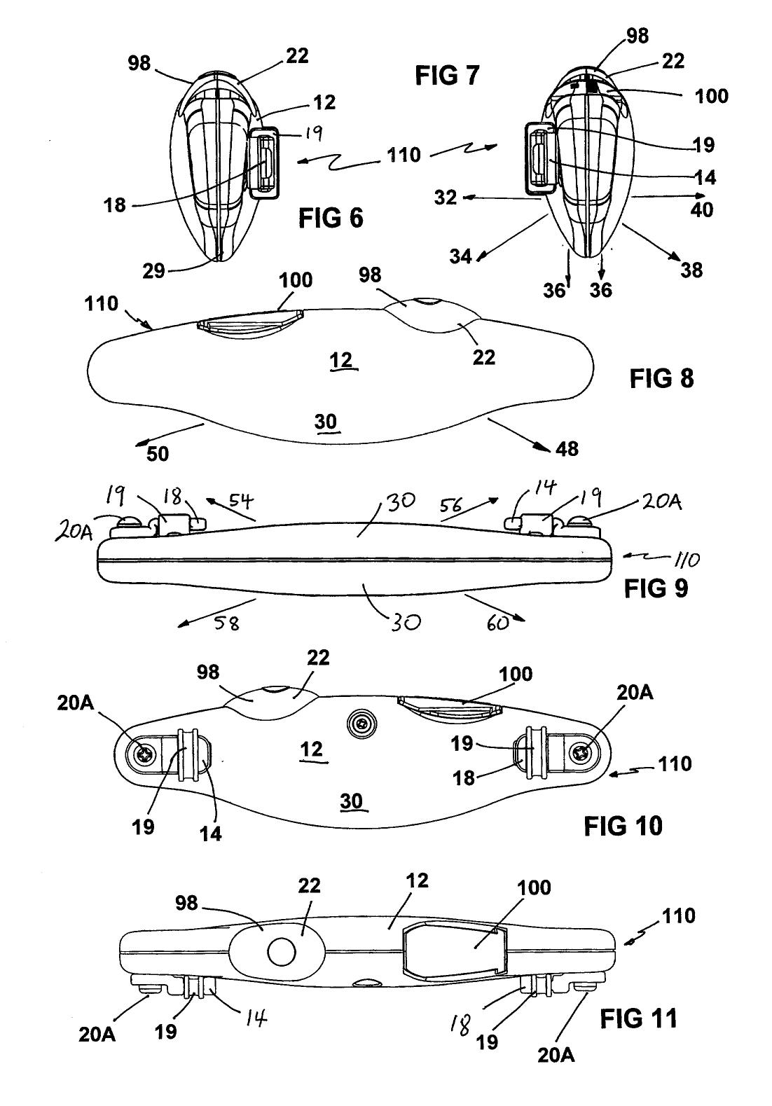

Illustrated in FIGS. 6 to 13 is another lighting device similar to that of FIGS. 1 to 5. Like parts and like features have been like numbered.

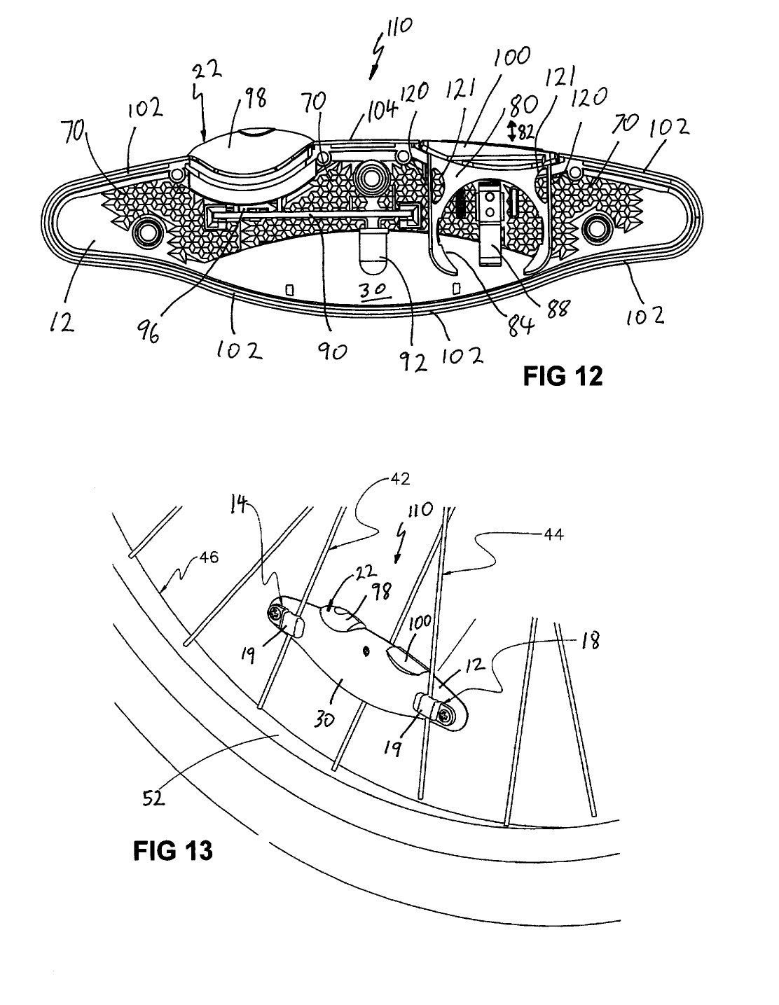

One difference between the lighting device 10 of FIGS. 1 to 5 and lighting device 110 of FIGS. 6 to 13 is that the body 12 of lighting device 110 is manufactured from two halves and includes the lens 30 integrally formed therewith. As can be seen from FIG. 12 the lens 30 is formed from the material of the body 12 and that portion which is not meant to act as a lens has reflector formations 70 moulded into the inside surface of the body. In this way the lighting device 110 will function in the same way as the lighting device 10 of FIGS. 1 to 5 and the body 12 of lighting device 110 will also act as a reflector.

Another difference between the lighting device 110 and lighting device 10 is that the hooks 14 and 18 are not translatable. Rather the hooks 14 and 18 are secured to the rear of the light by screws 20A. The hooks 14 and 18 are able to be rotated relative to the screws 20A so that the body of the hooks 18 and 14 can be secured at any appropriate angle to capture spokes 42 and 44. The hooks 14 and 18 in FIGS. 6 to 13 include tabular rubber mounts 19 which help to grip the spokes 32 and 44 in order to keep the lighting device 110 securely affixed to the spokes 42 and 44 without the possibility of the lighting device 110 sliding along the spokes 42 and 44.

As illustrated in FIG. 13, because of the rubber mounts 19 the spokes 42 and 44 can make an angle to the longitudinal axis of the lighting device 110. The mounts 19 being manufactured of rubber can readily accommodate this angular displacement.

Another difference between the lighting device 10 and lighting device 110 is that the battery compartment in the lighting device 10 was generally perpendicular to the part line in the body 10. Whereas in the lighting device 110, the battery is housed in a holder 80 having an approximately 20 mm circular bight 84 into which a 3 volt lithium cell can be situated. The bight 84 is bordered on either side by arms which cantilever away from the gripping portion 100. The size of the bight 84 is slightly smaller than the diameter of a lithium cell, so that the arms will apply a small amount of compressive force to a portion of the circumference of the lithium cell. The arms can include a small flange along the edge of the bight 84, so as to prevent a lithium cell being pushed through the bight 84.

The holder 80 holds the battery in a generally vertical orientation which is parallel or coincident with the plane of the part line 29. The battery being of a 3 volt lithium type and approximately 20 mm in diameter sits inside a battery housing 80 which slides into and out of a cavity in the body 12. The direction of sliding is in the plane of the path line 29 with movement being possible in the direction of arrows 82 (as illustrated in FIG. 12). The sides of the holder 80 can include detents 120 mounted on spring member 121 to engage the port in the body 12 through which the holder 80 passes so as to prevent the holder 80 from sliding out of the housing under the influence of gravity. The spring member 121 is formed by a D shaped aperture through the holder next to the detent 120. The holder 80, when the lighting device 110 is in use on a spoked wheel will be under a centrifugal force tending to keep the holder 80 in position in the body 12.

As the battery inside the battery holder 80 slides downwardly into the body 12, contacts 86 and 88 on either side of the holder 80 make contact with the positive and negative sides of the lithium cell. The contacts 86 and 88 are connected to a printed circuit board 90 on which is located an LED 92 and other components including a resistor 94 and a switch mechanism 96. The switch 96 has a rubber button cover 98 located there around so as to seal the port relative to the upper rim of the body 12 through which the switch 96 is to be operated. The switch assembly 22 is made up of the switch mechanism 96 and the rubber button cover 98.

A gasket type seal is provided on the under surface of the gripping portion 100 of the battery housing 80. Another gasket is provided around the longer outer edge 102 and a smaller gasket is positioned between the battery housing 80 and the button 98 along the shorter outer edge 104. Thus when the second half is placed on top of the half illustrated in FIG. 12 a substantially sealed unit is produced by means of the gaskets and the rubber button cover 98.

A reflector surface 70 as illustrated in FIG. 12 is made from a reflex reflector. The surfaces of a reflex reflector reflect by total internal reflection (because the refractive index of the plastic is greater than that of air, which is the medium behind the reflex). A reflex reflector is a collection of triple reflectors created from moulded plastic or polymer. A triple reflector is essentially the corner of a cube with the three planes perpendicular to each other, reflecting on the inside. A unique property of a triple reflector is that any ray incident on any one of the three surfaces reflects off the other two surfaces and emerges anti-parallel to the incident ray. This is because of the geometry of the triple reflector.

The reflector surface 70 allows the non lens portions of the body 12, (the body 12 of lighting device 110 being constructed from translucent or transparent material) to act as a reflector when in use. Alternatively, a reflective material such as a retroreflective material, can be applied or adhered to the non lens internal portions of a transparent body 12, to achieve a similar reflective result.

If desired reflective surface can be applied to the external surfaces of the body 12 in the lighting device 10 or the lighting device 110. Such a reflector surface can be a retroreflective material adhered to or otherwise connected to the external surfaces of the body 12. However in order to ensure that the lens area will properly transmit light, the lens areas of lighting devices 10 and 110 should remain transparent and or translucent to allow for the proper functioning of the lighting devices 10 and 110.

As can be seen from the lighting devices 10 and 110, the lens area 30 includes a bulbous portion made from two aerofoil shaped halves. The bulbous portion extends or is bulbous in a direction generally perpendicular to the longitudinal axis of the housing when viewed in front view or elevation of FIGS. 2 or 8. Further, a bulbous portion is also provided (by means of the aerofoil shaped halves of the housings 12 and the lenses 30) which extends or is bulbous in a direction generally perpendicular to the longitudinal axis of the housing when viewed in the plan view of FIGS. 3 or 9. These bulbous features allow the lighting devices 10 and 110 to emit light in the direction of arrows 48 and 50 of FIGS. 2 or 8 in front view and in the direction of arrows 54, 56, 58 and 60 of FIGS. 3 or 9 in underneath view.

The bulbous portions being made from two aerofoil shaped halves result in an aerofoil shape which, when mounted on the spokes of a wheel and is revolving with the wheel, presents an aerodynamically efficient shape, thus decreasing the amount of resistance provided to the rotation of the wheel about its axis of rotation by comparison to the previously known wheel mounted lights.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A lighting device having a housing to house a voltage source, a lamp means and a switch means, so that when said switch means closes a circuit between said source and said lamp means light will be emitted from said device, said housing including attachment means to attach said housing to a spoked wheel, whereby said housing allows a substantial proportion of light generated to be emitted in the direction of a rim of said spoked wheel and in a direction parallel to the axis of rotation of said spoked wheel and directions therebetween, said housing being of an aerofoil shape.

2. A lighting device as claimed in claim 1, wherein said aerofoil shape is constructed from back to back aerofoil shaped halves.

3. A lighting device as claimed in claim 2, wherein said housing includes a lens portion which is transparent or translucent through which said light will be emitted.

4. A lighting device as claimed in claim 3, wherein said attachment means are two engaging portions located on said housing at opposite ends thereof.

5. A lighting device as claimed in claim 4, wherein a first engaging portion is at one end of said device to engage a first spoke and a second engaging portion at an opposite end of said device to engage a second spoke to there by capture said spokes in said engaging portions.

6. A lighting device as claimed in claim 5, wherein at least one engaging portion is translatable.

7. A lighting device as claimed in claim 6, wherein said engaging portion which is translatable is mounted in a slot having a longitudinal axis which extends in the direction from said first to said second engaging portion.

8. A lighting device as claimed in claim 1, wherein said switch means is activated by movement of the lighting device.

9. A lighting device as claimed in claim 1, wherein said circuit is openable and closable intermittently.

10. A lighting device as claimed in claim 1, wherein said housing is bulbous in at least two directions which are orthogonal to a longitudinal axis of said housing.

11. A lighting device as claimed in claim 2, wherein said housing is made from a transparent or a non-transparent material.

12. A lighting device as claimed in claim 11, wherein said housing includes reflector formations and or surfaces thereon.

13. A lighting device as claimed in claim 11, wherein said housing is transparent with reflex reflector formations and or surfaces located on the inside of the housing in order to reflect light striking said housing from outside of said housing.

14. A lighting device as claimed in claim 11, wherein said lens portion is formed integral with said housing.

15. A lighting device as claimed in claim 11 wherein said lens is formed separately of said housing and attached thereto.

16. A lighting device as claimed in claim 15, wherein said lighting device includes a battery holder which slides into and out of said lighting device.

17. A lighting device as claimed in claim 16 wherein said holder includes a generally planar holding portion into which a battery can be placed.

18. A lighting device as claimed in claim 16, wherein said holding portion includes two cantilevered arms which hold said battery around a circumference thereof and which can apply a compressive force thereto.

19. A lighting device as claimed in claim 18, wherein said battery holder is adapted to hold a disc shaped cell, and to hold said cell in a plane generally parallel to a joining plane of halves of said lighting device.

20. A lighting device as claimed in claim 19, wherein said battery holder slides into and out of said lighting device through a port on the axle side of said lighting device when mounted on a spoked wheel.
